(19) United States
(12) Patent Application Publication
(10) Pub. No.: US 2026/0045110 A1
(43) Pub. Date: Feb. 12, 2026

(54) MULTI-MODAL DATA PROCESSING

(71) Applicant: TENCENT TECHNOLOGY (SHENZHEN) COMPANY LIMITED, Shenzhen (CN)

(72) Inventor: Dehui LI, Shenzhen (CN)

(73) Assignee: TENCENT TECHNOLOGY (SHENZHEN) COMPANY LIMITED, Shenzhen (CN)

(21) Appl. No.: 19/360,777

(22) Filed: Oct. 16, 2025

Related U.S. Application Data
(63) Continuation of application No. PCT/CN2024/109885, filed on Aug. 5, 2024.

(30) Foreign Application Priority Data
Oct. 12, 2023 (CN) 202311318866.2

(51) Int. Cl. G06V 20/70

(52) U.S. Cl. CPC G06V 20/70

(57) ABSTRACT

In a data processing method, input data is acquired. The input data includes image data. A label of the image data is acquired through a first multi-modal model and a word list. The label identifies at least one element present in the image data. The word list is defined for a recognition task and includes N words. N is a positive integer. Through a second multi-modal model and a second prompt, a text description of the image data is acquired. The second prompt controls generation of an image content description corresponding to the recognition task. First text information from the label and the text description is generated based on a target prompt. The target prompt is defined for the recognition task. The first text information is input into a large language model. A recognition result of the input data is output.

### RELATED APPLICATIONS

The present application is a continuation of International Application No. PCT/CN2024/109885, filed on Aug. 5, 2024, which claims priority to Chinese Patent Application No. 202311318866.2, filed on Oct. 12, 2023. The entire disclosures of the prior applications are hereby incorporated by reference.

### FIELD OF THE TECHNOLOGY

This application relates to the technical field of artificial intelligence, including a data processing method.

### BACKGROUND OF THE DISCLOSURE

Multi-modal recognition refers to simultaneously using data in multiple perceptual modalities as a model input and outputting a corresponding recognition result. Multi-modal recognition may fuse the data in the multiple perceptual modalities, to acquire richer and more comprehensive information and improve accuracy and robustness of a model.

Currently, some pre-trained multi-modal large models can well extract multi-modal features, but cannot directly implement a specific multi-modal recognition task, such as a classification task and a graphic and textual question-answering task. To implement the specific multi-modal recognition task, data needs to be labeled for the specific task, the model is trained according to a labeled data set or model fine tuning is performed, and then multi-modal recognition is performed by using the trained model.

However, data labeling and model training consume time and labor and consume high computing power costs and time costs, and execution efficiency of the multi-modal recognition task is low.

### SUMMARY

Aspects of this disclosure provide a data processing method, a data processing apparatus, and a non-transitory computer-readable storage medium, which can improve execution efficiency of a multi-modal recognition task, and reduce computing power costs and time costs of multi-modal recognition. Examples of technical solutions of this disclosure may be implemented as follows:

An aspect of this disclosure provides a data processing method. In the method, input data is acquired. The input data includes image data. A label of the image data is acquired through a first multi-modal model and a word list. The label of the image data identifies at least one element present in the image data. The word list is defined for a recognition task and includes N words. N is a positive integer. Through a second multi-modal model and a second prompt, a text description of the image data is acquired. The second prompt controls generation of an image content description corresponding to the recognition task. First text information from the label of the image data and the text description of the image data are generated based on a target prompt. The target prompt is defined for the recognition task. The first text information is input into a large language model. A recognition result of the input data is output.

An aspect of this disclosure provides a data processing apparatus. The apparatus includes processing circuitry configured to acquire input data. The input data includes image data. The processing circuitry is configured to acquire a label of the image data through a first multi-modal model and a word list. The label of the image data identifies at least one element present in the image data. The word list is defined for a recognition task and includes N words. N is a positive integer. The processing circuitry is configured to acquire, through a second multi-modal model and a second prompt, a text description of the image data. The second prompt controls generation of an image content description corresponding to the recognition task. The processing circuitry is configured to generate first text information from the label of the image data and the text description of the image data based on a target prompt. The target prompt is defined for the recognition task. The processing circuitry is configured to input the first text information into a large language model. The processing circuitry is configured to output a recognition result of the input data.

An aspect of this disclosure provides a data processing method, including: acquiring to-be-recognized data, the to-be-recognized data including image data; acquiring a label of the image data according to a pre-trained first multi-modal model and a preset word list, the label of the image data being configured for describing an element present in the image data; the word list being set according to a service scenario of a multi-modal recognition task, the word list including N words, and N being a positive integer; acquiring a text description of the image data according to a pre-trained second multi-modal model and a preset second prompt; the second prompt being configured for controlling generation of an image content description of interest to the multi-modal recognition task; generating first text information from the label of the image data and the text description of the image data according to a preset target prompt, the target prompt being set according to the service scenario of the multi-modal recognition task; and inputting the first text information into a pre-trained large language model, and outputting a recognition result of the to-be-recognized data.

An aspect of this disclosure provides a data processing apparatus, including: a first acquiring module, configured to acquire to-be-recognized data, the to-be-recognized data including image data; a second acquiring module, configured to acquire a label of the image data according to a pre-trained first multi-modal model and a preset word list, the label of the image data being configured for describing an element present in the image data; the word list being set according to a service scenario of a multi-modal recognition task, the word list including N words, and N being a positive integer; a third acquiring module, configured to acquire a text description of the image data according to a pre-trained second multi-modal model and a preset second prompt; the second prompt being configured for controlling generation of an image content description of interest to the multi-modal recognition task; a processing module, configured to generate first text information from the label of the image data and the text description of the image data according to a preset target prompt, the target prompt being set according to the service scenario of the multi-modal recognition task; and the processing module, further configured to input the first text information into a pre-trained large language model, and output a recognition result of the to-be-recognized data.

An aspect of this disclosure provides an electronic device, including: a processor, adapted to implement a computer instruction; and a memory, having computer instructions stored therein, the computer instructions being adapted to be loaded by the processor to perform the methods provided in the foregoing aspects.

An aspect of this disclosure provides a non-transitory computer-readable storage medium storing instructions which, when executed by a processor, cause the processor to implement the methods provided in the foregoing aspects.

An aspect of this disclosure provides a computer program product or a computer program. The computer program product or the computer program includes computer instructions. The computer instructions are stored in a computer-readable storage medium. A processor of a computer device reads the computer instructions from the computer-readable storage medium, and the processor executes the computer instructions, so that the computer device performs the methods provided in the foregoing aspects.

By means of the foregoing technical solutions, after the to-be-recognized data is acquired, the label of the image data in the to-be-recognized data is acquired by using the pre-trained first multi-modal model and the preset word list, and the text description of the image data is acquired according to the pre-trained second multi-modal model and the preset second prompt. Next, the first text information is generated from the label of the image data and the text description of the image data according to the preset target prompt, and reasoning is performed on the first text information by using the pre-trained large language model to obtain the recognition result of the to-be-recognized data. Because the preset word list plays a role in prompting the acquiring of the image label, the second prompt plays a role in prompting the acquiring of text representation, and the first text information obtained according to the target prompt plays a role in prompting recognition of the to-be-recognized data by the large language model, in the aspects of this disclosure, the capability of the pre-trained large language model can be fully used, multi-modal recognition tasks in different service scenarios can be implemented without data labeling and model training, and computing power costs and time costs of the multi-modal recognition are reduced, thereby promoting practical application of the multi-modal recognition in each service scenario.

### BRIEF DESCRIPTION OF THE DRAWINGS

FIG. 1 is a schematic diagram of an application scenario involved in aspects of this disclosure.

FIG. 2 is a flowchart of a data processing method provided in an aspect of this disclosure.

FIG. 3 is a flowchart of another data processing method provided in an aspect of this disclosure.

FIG. 4 is a schematic diagram of a data processing framework provided in an aspect of this disclosure.

FIG. 5 is a schematic diagram of a process of acquiring a label of image data provided in an aspect of this disclosure.

FIG. 6 is a schematic block diagram of a data processing apparatus provided in an aspect of this disclosure.

FIG. 7 is a schematic block diagram of an electronic device 30 provided in an aspect of this disclosure.

### DETAILED DESCRIPTION

Examples of technical solutions in aspects of this disclosure are described in the following with reference to the accompanying drawings. The described aspects are merely some rather than all of the aspects of this disclosure. Other aspects shall fall within the scope of this disclosure. The descriptions of the terms are provided as examples only and are not intended to limit the scope of the disclosure.

In the aspects of this disclosure, “B corresponding to A” indicates that B is associated with A. In an implementation, B may be determined according to A. However, determining B according to A does not mean that B is determined according to only A, and B may alternatively be determined according to A and/or another information.

In the description of this disclosure, unless otherwise stated, “at least one” means one or more, and “plurality of” means two or more than two. In addition, “and/or” describes an association relationship of associated objects and represents that three relationships may exist. For example, A and/or B may represent the following three cases: only A exists, both A and B exist, and only B exists, where A and B may be singular or plural. The character “/” represents that the association objects before and after the character are in an “or” relationship. “At least one of the following items” or a similar expression means any combination of these items, including a single item or any combination of a plurality of items. For example, at least one of a, b, or c may represent a, b, c, “a and b”, “a and c”, “b and c”, or “a, b, and c”, where a, b, and c may be single or multiple.

Descriptions such as first and second in the aspects of this disclosure are merely used for illustrating and distinguishing the described objects, without any order or a particular limitation on the number of devices in the aspects of this disclosure, and cannot be construed as any limitation on the aspects of this disclosure.

Particular features, structures, or characteristics related to the aspects in the specification are included in at least one aspect of this disclosure. In addition, these particular features, structures or characteristics may be combined in one or more aspects in any appropriate manner.

Moreover, the terms “include”, “have” and any other variants mean to cover the non-exclusive inclusion, for example, a process, method, system, product, or server that includes a list of operations or units is not necessarily limited to those expressly listed operations or units, but may include another operation or unit not expressly listed or inherent to such a process, method, product, or device.

First, relevant terms involved in the aspects of this disclosure are described.
1. Multi-modal recognition: data input models in multiple modalities are simultaneously used and corresponding recognition results are outputted. For example, multi-modal recognition is performed simultaneously based on image data, text data, and audio data.
2. Pre-training model (PTM): also referred to as a cornerstone model or a large model, referring to a deep neural network (DNN) having massive parameters. The PTM is trained on massive unmarked data. A function approximation capability of the DNN having the massive parameters enables the PTM to extract a common feature from the data. The PTM is applicable to downstream tasks via technologies such as fine tune, parameter efficient fine tuning (PEFT), and prompt-tuning. Therefore, the pre-training model may achieve an ideal effect in a few-shot scenario or a zero-shot scenario. The PTM may be classified into language models (ELMO, BERT, GPT), visual models (swin-transformer, ViT, V-MOE), speech models (VALL-E), multi-modal models (ViBERT, CLIP, Flamingo, Gato), and the like according to processed data modalities. The multi-modal model refers to a model that establishes two or more data modal feature representations. The pre-training model is an important tool for outputting artificial intelligence-generated content (AIGC), and may also be used as a general interface for connecting a plurality of specific task models.
3. Zero-shot: in a conventional machine learning method, dedicated training needs to be performed for each task, and a model needs to be re-trained for a new task. The zero-shot learning technology may be used to perform prediction or reasoning by using a trained model in a case where there is no training data for a particular task. Training of a large model usually needs to be supported by relatively high computing power, and training time is relatively long. However, the zero-shot technology does not need to re-label samples and train the model, which can greatly reduce costs and periods of model development.

FIG. 1 is a schematic diagram of an application scenario involved in aspects of this disclosure. As shown in FIG. 1, the application scenario includes a terminal device 102 and a server 104. The terminal device 102 is in communication with the server 104 through a network. The server 104 may be, but is not limited to, configured to provide services to the terminal device 102 or a client installed on the terminal device 102. The client may include a video client, an instant messaging client, a browser client, a game client, and the like, which is not limited.

In some aspects, as shown in FIG. 1, the server 104 may further be connected to a data storage system 106, such as a database, configured to provide a data storage service for the server 104. The data storage system may be integrated on the server 104, or deployed on a cloud or another server, which is not limited.

In some implementations, the terminal device 102 refers to a device that has abundant human-computer interaction manners, has a capability of accessing the Internet, usually carries various operating systems, and has a relatively strong processing capability. The terminal device 102 may be a smartphone, a tablet computer, a portable laptop, a desktop computer, a wearable device, an in-vehicle device, or the like, but is not limited thereto. In an aspect of this disclosure, an application having a multi-modal recognition function is installed in the terminal device 102.

In some aspects, an application of a multi-modal recognition service is installed on the terminal device 102. The above multi-modal recognition service may be used through an ingress of the multi-modal recognition application configured on the terminal device 102. For example, a page for uploading to-be-recognized data may be displayed through a display interface of the application by using the data processing method provided in the aspects of this disclosure based on the application. The display interface of the application may be, but is not limited to, displayed by using the terminal device 102. The foregoing description is merely an example. This is not limited in this aspect.

For example, the server 104 may be an independent physical server, or may be a server cluster or a distributed system that is composed of a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The server may also become a node in a blockchain. There may be one or more servers. When there are a plurality of servers, at least two servers are configured to provide different services, and/or, at least two servers are configured to provide the same service. For example, the same service is provided in a load balancing manner, which is not limited in the aspect of this disclosure.

For example, the network may be a wireless or wired network such as an Intranet, the Internet, a global system for mobile communication (GSM), wideband code division multiple access (WCDMA), a 4^{th} Generation (4G) network, a 5^{th} Generation (5G) network, Bluetooth, Wi-Fi, or a call network.

The data processing method provided in this aspect may be performed by the above server 104, or may be performed by the above terminal device 102, or may be performed jointly by the above terminal device 102 and server 104. In an aspect, the terminal device 102 may send the to-be-recognized data to the server 104, and the server 104 performs the data processing method provided in the aspect of this disclosure, to obtain a recognition result of the to-be-recognized data.

FIG. 1 is merely an example description, and does not specifically limit the application scenario of the aspect of this disclosure.

In the related art, to implement a specific multi-modal recognition task, data needs to be labeled for the specific task, a model is trained according to a labeled data set, or model fine tuning is performed, and then multi-modal recognition is performed by using the trained model. However, data labeling and model training consume time and labor and consume high computing power costs and time costs, and execution efficiency of the multi-modal recognition task is low.

In view of this, aspects of this disclosure provide a data processing method and apparatus, a device, and a storage medium, which can implement a multi-modal recognition task without data labeling and model training, thereby improving execution efficiency of the multi-modal recognition task, and reducing computing power costs and time costs of multi-modal recognition.

Specifically, to-be-recognized data may be acquired, and the to-be-recognized data includes image data. A label of the image data is acquired according to a pre-trained first multi-modal model and a preset word list, and the label of the image data is configured for describing an element present in the image data. A text description of the image data is acquired according to a pre-trained second multi-modal model and a preset second prompt. Next, first text information is generated from the label of the image data and the text description of the image data according to a target prompt, where the target prompt is set according to a service scenario of a multi-modal recognition task. The first text information is inputted into a pre-trained large language model, and a recognition result of the to-be-recognized data is outputted.

According to the aspect of this disclosure, after the to-be-recognized data is acquired, the label of the image data in the to-be-recognized data is acquired by using the pre-trained first multi-modal model and the preset word list, and the text description of the image data is acquired according to the pre-trained second multi-modal model and the preset second prompt. Next, the first text information is generated from the label of the image data and the text description of the image data according to the preset target prompt, and reasoning is performed on the first text information by using the pre-trained large language model to obtain the recognition result of the to-be-recognized data. Because the preset word list plays a role in prompting the acquiring of the image label, the second prompt plays a role in prompting the acquiring of text representation, and the first text information obtained according to the target prompt plays a role in prompting recognition of the to-be-recognized data by the large language model, in the aspects of this disclosure, the capability of the pre-trained large language model can be fully used, multi-modal recognition tasks in different service scenarios can be implemented without data labeling and model training, and computing power costs and time costs of the multi-modal recognition are reduced, thereby promoting practical application of the multi-modal recognition in each service scenario.

The data processing method provided in the aspect of this disclosure can be applied to different service scenarios, such as an intelligent cabin, real-time environment recognition, security and risk control of network information, security recognition, medical diagnosis, and intelligent interaction. Illustration is given below in detail with examples.

For example, in the intelligent cabin, information such as a passenger status and an environment scenario usually needs to be perceived, and then corresponding cabin services are provided with reference to the information. In combination with multi-modal information such as an image and sound, more robust perception and recognition can be implemented, thereby providing more precise, intelligent and user-friendly cabin services. For example, in an aspect, whether a passenger is tense, pleasant, and tired is recognized, so as to provide a corresponding service and adjustment measure, such as adjusting music playback and adjusting a seat angle. In another aspect, a multi-modal recognition technology is used to monitor behaviors of a passenger in real time, for example, whether the passenger is distracted or uses a mobile phone in a driving process, so as to provide safety guarantee services such as safety reminding and automatic braking. In still another aspect, the environment is recognized and analyzed in real time by using a multi-modal recognition technology. For example, a sunny day, a rainy day, a foggy day, or a red light is recognized, and services such as adjusting an air conditioner, turning on a wiper, turning on a fog light, and querying whether to play music for diversion are actively initiated.

In security and risk control of the network information, because the information relates to multiple forms such as an image, a video, an audio, and a text, multiple forms of information may be combined by using the multi-modal recognition, so as to implement more precise recognition and more robust risk control. For example, in an aspect, information such as an image frame, a text, and a sound in content such as a network video and a web page is recognized through multi-modal recognition, to determine whether the content belongs to porn, vulgar and softcore content. In another aspect, a malicious code may be recognized and analyzed in real time by using image recognition and text recognition technologies. For example, a virus, a Trojan horse, or a malicious link is recognized, thereby preventing and avoiding a malicious attack in time. By using the image recognition and text recognition technologies, a network security log may be analyzed and mined. For example, abnormal login, file operations, and the like are recognized, so as to find an abnormal event in time and provide corresponding countermeasures.

The technical solutions of the aspects of this disclosure are described in further detail in the following with reference to some aspects as examples. The following aspects may be mutually combined, and the same or similar concepts or processes may not be repeatedly described in some aspects.

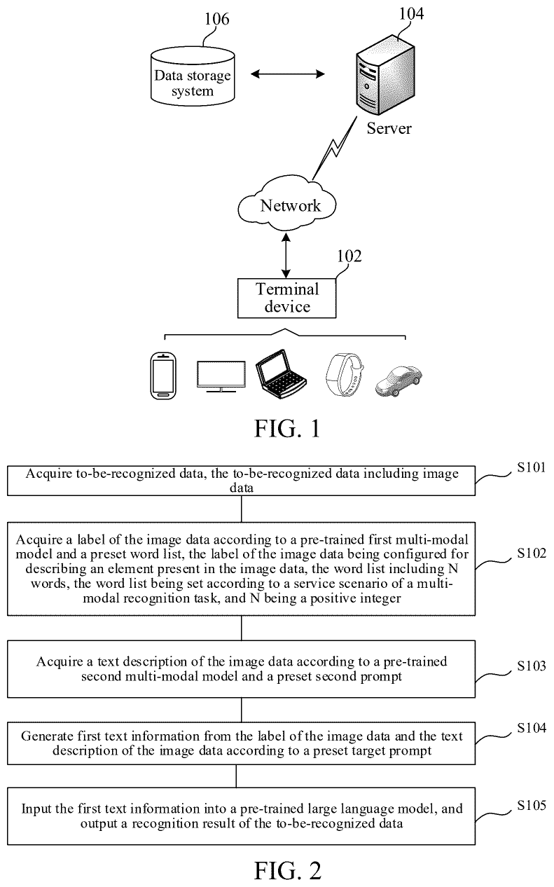

FIG. 2 is a flowchart of a data processing method provided in an aspect of this disclosure. An executing body of the aspect of this disclosure is an apparatus having a multi-modal recognition function. The apparatus, for example, may be a server or a terminal device. As shown in FIG. 2, the method may include:

S101: Acquire to-be-recognized data, the to-be-recognized data including image data. For example, input data is acquired. The input data includes image data.

Specifically, the to-be-recognized data is a recognition object corresponding to the data processing method provided in the aspect of this disclosure, and may include the image data. In some aspects, the to-be-recognized data may be multi-modal information. For example, the to-be-recognized data may include both image data and text data, or the to-be-recognized data may also include image data, text data, and audio data, and the like at the same time. As an example, the text data may be text data configured for commenting on the image data.

The image data may be an image extracted from a to-be-recognized object, such as one or more frames of images extracted from a segment of video. The text data may be text content built in the to-be-recognized data, and may include a content text, an abstract text, and a text built in the content.

In an aspect, acquiring the to-be-recognized data may be: receiving the inputted to-be-recognized data, the to-be-recognized data including the image data. Acquiring the to-be-recognized data may further be: receiving inputted video data and text data; extracting one or more frames of images in the video data so as to obtain the image data; and obtaining the to-be-recognized data according to the obtained image data and the text data.

S102: Acquire a label of the image data according to a pre-trained first multi-modal model and a preset word list, the label of the image data being configured for describing an element present in the image data, the word list including N words, the word list being set according to a service scenario of a multi-modal recognition task, and N being a positive integer. For example, a label of the image data is acquired through a first multi-modal model and a word list. The label of the image data identifies at least one element present in the image data. The word list is defined for a recognition task and includes N words. N is a positive integer.

Specifically, the image data may be one sheet of image, or may be one or more frames of images extracted from a segment of video. The label of the image data is configured for describing the element present in the image data. That is, the label of the image data is configured for describing the element present in the image. For example, one sheet of image includes a dog, and an element in the sheet of image includes an animal category-dog, a size of the dog, a color of the hair of the dog, and whether teeth of the dog are sharp.

The first multi-modal model is a pre-trained model. For example, the first multi-modal model may be a contrastive language-image pre-training (CLIP) model or another model, which is not limited in this aspect. The preset word list is set according to the service scenario of the multi-modal recognition task. The service scenario may be, for example, an intelligent cabin, real-time environment recognition, security and risk control of network information, security recognition, medical diagnosis, intelligent interaction, or the like. The word list includes N words. Taking a service scenario of vulgar content recognition as an example in this aspect, the word list may include word 1, word 2, word 3, word 4, word 5, word 6, and the like.

In some aspects, the acquiring a label of the image data according to a pre-trained first multi-modal model and a preset word list in S102 may be specifically:

S11: Obtain N pieces of second text information from each word in the word list separately according to a preset first prompt.

Specifically, the preset first prompt may be set according to a specific service scenario. For example, the first prompt is: a photograph about {XX}, and one piece of second text information is obtained from each word in the word list according to “a photograph about {XX}”. For example, the word list includes five words, one word is “word 2”, and a text formed by word 2 according to “a photograph about {XX}” is: a photograph about {word 2}. In this example, the N pieces of second text information is a text formed by “a photograph about {XX}” corresponding to the five words.

S12: Input the second text information into a text encoder of the first multi-modal model, and output embedding features of the N pieces of second text information.

Specifically, the text in each piece of second text information is inputted into the text encoder of the first multi-modal model, and an embedding feature of each piece of second text information is outputted, to obtain the embedding features of the N pieces of second text information.

S13: Input the image data into an image encoder of the first multi-modal model, and output an embedding feature of the image data.

Specifically, the image data is inputted into the image encoder of the first multi-modal model, and the embedding feature of the image data is extracted and outputted.

S14: Determine the label of the image data according to similarities between the embedding feature of the image data and the embedding features of the N pieces of second text information, the label of the image data including at least one word in the word list.

For example, the similarity herein may be a cosine similarity. For the embedding feature of each of the N pieces of second text information, a cosine similarity between the embedding feature of the image data and the embedding feature of each piece of second text information may be calculated. Specifically, a cosine distance between the two may be calculated. The similarity between the embedding feature of the image data and the embedding feature of each piece of second text information is obtained. The label of the image data may be determined according to the similarity between the embedding feature of the image data and the embedding feature of each piece of second text information. The label of the image data includes at least one word in the word list.

In an aspect, the determining the label of the image data according to the similarities between the embedding feature of the image data and the embedding features of the N pieces of second text information in S14 may be specifically S141 and S142.

S141: Normalize the similarities between the embedding feature of the image data and the embedding features of the N pieces of second text information, to obtain confidences of the N pieces of second text information.

Specifically, the similarity between the embedding feature of the image data and the embedding feature of each piece of second text information is normalized (softmax), to obtain the confidences of the N pieces of second text information.

S142: Select, according to a descending order of the confidences, words corresponding to first k pieces of second text information having highest confidences as k labels, k being a preset positive integer.

In an aspect, S14 may further include S143: Filter the k labels according to a preset filtering mode, and determine a label remaining after the filtering as the label of the image data.

The preset filtering mode may include: reserving, for two labels having opposite meanings, a label whose confidence is the maximum. For example, the two labels are word 1 and word 2, and if a confidence of the label “word 2” is the maximum of the two labels, the label “word 2” is reserved.

S103: Acquire a text description of the image data according to a pre-trained second multi-modal model and a preset second prompt. For example, through a second multi-modal model and a second prompt, a text description of the image data is acquired. The second prompt controls generation of an image content description corresponding to the recognition task.

The second prompt is configured for controlling generation of an image content description of interest to the multi-modal recognition task. The text description of the image data is configured for describing content of the image data.

Specifically, the second multi-modal model may be, for example, BLIP-2. The second prompt may be preset according to the service scenario of the multi-modal recognition task, and the second prompt is configured for controlling generation of the image content description of interest to the multi-modal recognition task. For example, in this aspect, taking a service scenario of vulgar content recognition as an example, the second prompt may be “describing clothes and the figure of a person in an image”.

In an aspect, the acquiring a text description of the image data according to a pre-trained second multi-modal model and a preset second prompt in S103 may be specifically: inputting the image data and the second prompt into the second multi-modal model, and outputting the text description of the image data.

Still taking the service scenario of vulgar content recognition as an example, the second prompt may be “describing clothes and the figure of a person in an image”. The image data and the second prompt “describing clothes and the figure of a person in an image” are inputted into the second multi-modal model, and the outputted text description of the image data may be, for example, “word 4 and word 3 of a task in an image”.

S104: Generate first text information from the label of the image data and the text description of the image data according to a preset target prompt, the target prompt being set according to the service scenario of the multi-modal recognition task. For example, first text information from the label of the image data and the text description of the image data is generated based on a target prompt. The target prompt is defined for the recognition task.

In some aspects, the target prompt corresponding to the to-be-recognized data may be determined from at least one preset prompt. Specifically, a plurality of prompts may be preset and stored, and each prompt corresponds to content included in the to-be-recognized data. For example, when the to-be-recognized data includes the image data, the to-be-recognized data corresponds to one prompt. When the to-be-recognized data includes the image data and the text data, the to-be-recognized data corresponds to one prompt. When the to-be-recognized data includes the image data, the text data, and audio data, the to-be-recognized data corresponds to another prompt. After the to-be-recognized data is acquired, the content included in the to-be-recognized data may be learned, and further, the target prompt corresponding to the to-be-recognized data may be determined according to the content included in the to-be-recognized data.

In some aspects, each of the at least one preset prompt is set according to the service scenario of the multi-modal recognition task, and different service scenarios correspond to different prompts.

After the target prompt corresponding to the to-be-recognized data is determined, a piece of text information, namely the foregoing first text information, is generated from the label of the image data and the text description of the image data according to the target prompt.

In some aspects, when the to-be-recognized data includes the text data, operation S104 may be specifically: forming the first text information from the label of the image data, the text description of the image data, and the text data according to the target prompt.

In some aspects, when a recognition result of the to-be-recognized data is a type to which the text data in the to-be-recognized data belongs, operation S104 above may be specifically: generating the first text information from the label of the image data, the text description of the image data, the text data, and at least one classification type of the text data according to the target prompt.

When the multi-modal recognition task is a classification task of the text data in the to-be-recognized data, the recognition result of the to-be-recognized data is the type to which the text data in the to-be-recognized data belongs. In some aspects, possible classification types corresponding to the text data may be preset and stored. For example, taking the service scenario of vulgar content recognition as an example, the at least one classification type of the text data may include normal text data, vulgar text data, and the like.

S105: Input the first text information into a pre-trained large language model, and output a recognition result of the to-be-recognized data. For example, the first text information is input into a large language model. A recognition result of the input data is output.

Specifically, after the first text information is inputted into the pre-trained large language model, the large language model may perform reasoning according to the inputted first text information, to generate the recognition result of the to-be-recognized data. In some aspects, the large language model in this aspect may be, for example, an LLM.

For example, the recognition result of the to-be-recognized data may include a type of the image data. For another example, the recognition result of the to-be-recognized data may include a type of the text data.

Further, in an implementation, when the to-be-recognized data further includes the audio data, the method of this aspect may further include:

S106: Acquire a speech text corresponding to the audio data.

Specifically, in an aspect, a pre-trained speech recognition model may be used to acquire the speech text corresponding to the audio data, the audio data is inputted to the speech recognition model, and the speech text corresponding to the audio data is outputted. In some aspects, the speech text corresponding to the audio data may also be acquired in another mode, which is not limited in this aspect.

Correspondingly, when the to-be-recognized data further includes the audio data, S104 may be specifically: forming one piece of text information from the label of the image data, the text description of the image data, and the speech text according to the target prompt.

In a specific example, taking an example in which the multi-modal recognition task is a classification task, the target prompt is “{ } exists in a picture, picture content is { }, corresponding speech content is { }, comments on the picture are { }, and which type in {XX, XX, XX} do the comments belong to?”. The label of the image data is, for example, label 1, the text description of the image data is, for example, text description 1, the text data is, for example, text data 1, the speech text is, for example, speech text 1, and the classification type includes a normal type, a vulgar type, and an abuse type. One piece of text information is formed from the label of the image data, the text description of the image data, the text data, the speech text, and the type of the text data according to the target prompt. The text information is: “{label 1} exists in the picture, the picture content is {text description 1}, the corresponding speech content is {speech text 1}, comments on the picture are {text data 1}, which type in {normal type, vulgar type, abuse type} do the comments belong to?”.

In some aspects, if the data processing method of this aspect is performed by a terminal device, the terminal device performs a corresponding operation according to the recognition result of the to-be-recognized data. For example, the terminal device displays corresponding indication information according to the recognition result of the to-be-recognized data. If the data processing method of this aspect is performed by a server, the server performs a corresponding operation according to the recognition result of the to-be-recognized data. For example, the server sends a corresponding operation instruction to the terminal device according to the recognition result of the to-be-recognized data. The terminal device performs a corresponding operation according to the operation instruction.

According to the data processing method provided in this aspect, after the to-be-recognized data is acquired, the label of the image data in the to-be-recognized data is acquired by using the pre-trained first multi-modal model and the preset word list, and the text description of the image data is acquired according to the pre-trained second multi-modal model and the preset second prompt. Next, the first text information is generated from the label of the image data and the text description of the image data according to the preset target prompt, and reasoning is performed on the first text information by using the pre-trained large language model to obtain the recognition result of the to-be-recognized data. Because the preset word list plays a role in prompting the acquiring of the image label, the second prompt plays a role in prompting the acquiring of text representation, and the first text information obtained according to the target prompt plays a role in prompting recognition of the to-be-recognized data by the large language model, in the aspects of this disclosure, the capability of the pre-trained large language model can be fully used, multi-modal recognition tasks in different service scenarios can be implemented without data labeling and model training, and computing power costs and time costs of the multi-modal recognition are reduced, thereby promoting practical application of the multi-modal recognition in each service scenario.

The following illustrates the technical solutions of this disclosure in further detail with reference to a specific aspect. In the following aspect, an example in which the multi-modal recognition task is livestreaming comment classification is used.

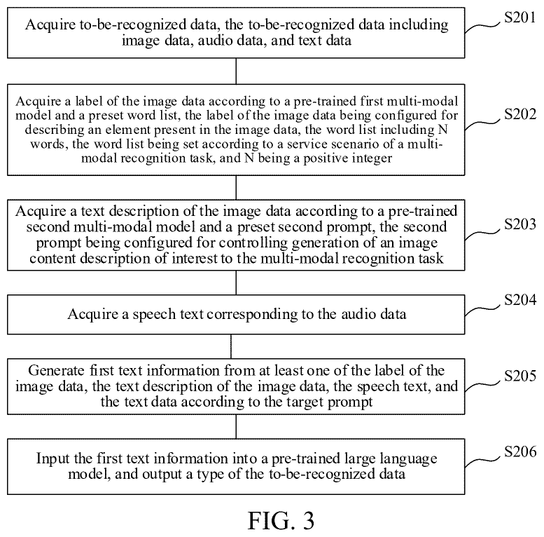

FIG. 3 is a schematic flowchart of a data processing method provided in an aspect of this disclosure. An executing body of the aspect of this disclosure is an apparatus having a multi-modal recognition function. The apparatus, for example, may be a server or a terminal device. In combination with FIG. 3, the method of this aspect may include:

S201: Acquire to-be-recognized data, the to-be-recognized data including image data, audio data, and text data. For example, input data is acquired. The input data includes image data. In an example, audio data included in the input data is acquired. For example, text data included in the input data is acquired.

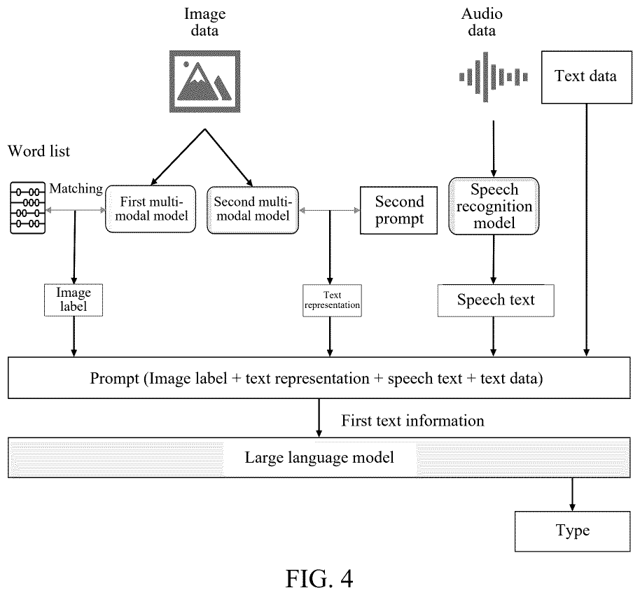

For example, referring to FIG. 4, the to-be-recognized data may include image data, as well as audio data and text data corresponding to the image data. Taking the livestreaming comment classification as an example, the to-be-recognized data includes image data, text data commenting on the image data, and audio data in a first time period corresponding to the image data. That is, the text data is a current comment, the image data is a screen image corresponding to the current comment, and the audio data is audio within a time period of the current comment. An objective of the aspect of this disclosure is to classify the text data. For example, classification categories may include three categories: a normal category, a vulgar category, and a non-friendly category.

For example, the image data may include videos. For example, when the screen image corresponding to the current comment is acquired, one or more frames of images of a screen corresponding to the current comment may be acquired. The screen image corresponding to the current comment, the audio within the time period of the current comment, and text content of the current comment may be acquired by the terminal device or the server in a livestreaming process.

S202: Acquire a label of the image data according to a pre-trained first multi-modal model and a preset word list, the label of the image data being configured for describing an element present in the image data, the word list including N words, the word list being set according to a service scenario of a multi-modal recognition task, and N being a positive integer. For example, a label of the image data is acquired through a first multi-modal model and a word list. The label of the image data identifies at least one element present in the image data. The word list is defined for a recognition task and includes N words. N is a positive integer.

For example, still referring to FIG. 4, the image data may be inputted into the first multi-modal model, and, by using the preset word list, the label of the image is acquired by, for example, matching with the N words in the word list.

The first multi-modal model is a pre-trained model. The first multi-modal model may be, for example, a CLIP model, or another model, which is not limited in this aspect. The preset word list is set according to the service scenario of the multi-modal recognition task. The service scenario may be, for example, an intelligent cabin, real-time environment recognition, security and risk control of network information, security recognition, medical diagnosis, intelligent interaction, or the like. The word list includes N words. Taking a service scenario of livestreaming comment classification as an example in this aspect, the word list may include word 1, word 2, word 3, word 4, word 5, and word 6.

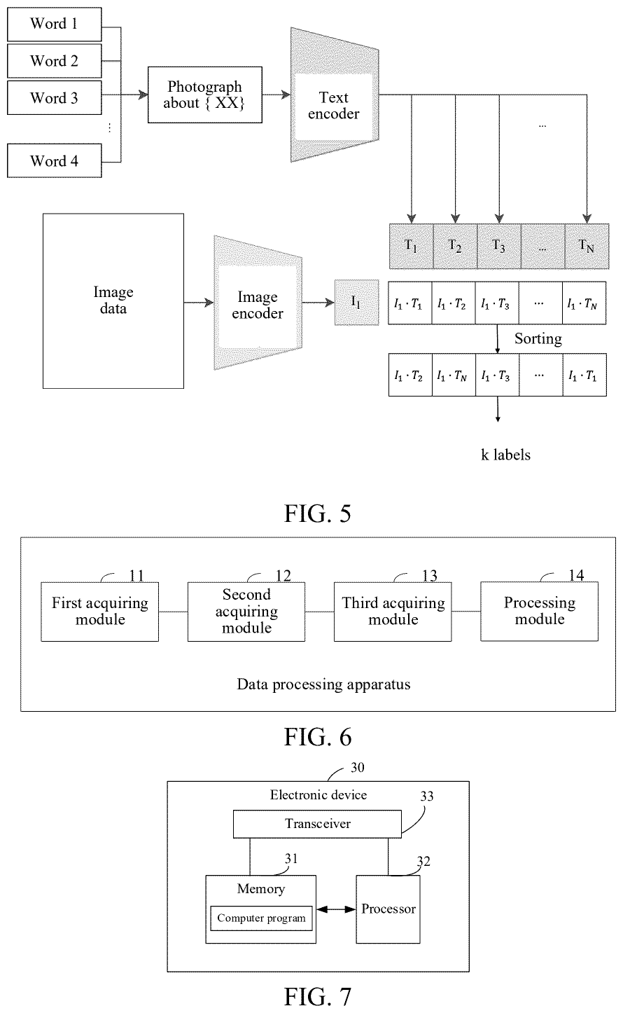

For example, FIG. 5 is a schematic diagram of a process of acquiring the label of the image data provided in an aspect of this disclosure. As shown in FIG. 5, the word list in this aspect includes word 1, word 2, word 3, word 4, and the like. In operation S202, each word in the word list may form a text (an example of the foregoing second text information) according to a preset first prompt. As shown in FIG. 5, for example, the first prompt is: a photograph about {XX}, and one text is formed from each word in the word list according to “a photograph about {XX}”. For example, the word list includes N words, and N texts are corresponding obtained. For example, one word is “word 2”, and a text formed by the word according to “a photograph about {XX}”is: a photograph about {word 2}.

Then, for the N obtained texts, each of the N texts is inputted into a text encoder of the first multi-modal model, and an embedding feature of each text is outputted, to obtain embedding features T1, T2, T3, . . . , and TN of the N texts.

Still referring to FIG. 5, the image data may be inputted into an image encoder of the first multi-modal model to extract an embedding feature I₁ of the image data.

Next, the label of the image data is determined according to a similarity between the embedding feature I₁ of the image data and an embedding feature (Tn, n=1, 2, . . . , N) of each text, and the label of the image data includes at least one word in the word list. For example, in FIG. 5, the similarity between the embedding feature I₁ of the image data and the embedding feature (Tn) of an n^{th} text may be expressed as I₁·Tₙ.

In some aspects, the similarity between the embedding feature of the image data and the embedding feature of each text may further be normalized (softmax), to obtain confidences of the N texts.

Still referring to FIG. 5, sorting may be performed in descending order of the similarities (or the confidences), and words corresponding to first k texts having highest similarities (or confidences) are selected as k labels, where k is a preset positive integer.

In some aspects, the k labels may be further filtered according to a preset filtering mode, and a label remaining after the filtering is determined as the label of the image data. The preset filtering mode may include: reserving, for two labels having opposite meanings, a label whose confidence is the maximum. For example, the two labels are word 1 and word 2, and if a confidence of the label “word 2” is the maximum of the two labels, the label “word 2” is reserved.

S203: Acquire a text description of the image data according to a pre-trained second multi-modal model and a preset second prompt, the second prompt being configured for controlling generation of an image content description of interest to the multi-modal recognition task. For example, through a second multi-modal model and a second prompt, a text description of the image data is acquired. The second prompt controls generation of an image content description corresponding to the recognition task.

For example, still referring to FIG. 4, the image data may be inputted into the second multi-modal model, and the text description of the image data is obtained with reference to the preset second prompt.

Specifically, the second multi-modal model may be, for example, BLIP-2. The second prompt may be preset according to the service scenario of the multi-modal recognition task, and the second prompt is configured for controlling generation of the image content description of interest to the multi-modal recognition task. For example, in this aspect, the second prompt may be “describing clothes and the figure of a person in an image”.

S204: Acquire a speech text corresponding to the audio data. For example, recognized speech text corresponding to the audio data is acquired.

For example, still referring to FIG. 4, a pre-trained speech recognition model may be used to acquire the speech text corresponding to the audio data. For example, the audio data is inputted to the speech recognition model, and the speech text corresponding to the audio data is outputted. In some aspects, the speech text corresponding to the audio data may also be acquired in another mode, which is not limited in this aspect.

S205: Generate first text information from at least one of the label of the image data, the text description of the image data, the speech text, and the text data according to a target prompt, the target prompt being set according to the service scenario of the multi-modal recognition task. For example, first text information from the label of the image data and the text description of the image data is generated based on a target prompt. The target prompt is defined for the recognition task.

For example, the target prompt corresponding to the to-be-recognized data may be determined from at least one preset prompt. Specifically, a plurality of prompts may be preset and stored, and each prompt corresponds to content included in the to-be-recognized data. For example, when the to-be-recognized data includes the image data, the to-be-recognized data corresponds to one prompt. When the to-be-recognized data includes the image data and the text data, the to-be-recognized data corresponds to one prompt. When the to-be-recognized data includes the image data, the text data, and audio data, the to-be-recognized data corresponds to another prompt. After the to-be-recognized data is acquired, the content included in the to-be-recognized data may be learned, and further, the target prompt corresponding to the to-be-recognized data may be determined according to the content included in the to-be-recognized data.

Each of the at least one preset prompt is set according to the service scenario of the multi-modal recognition task, and different service scenarios correspond to different prompts.

After the target prompt corresponding to the to-be-recognized data is determined, the first text information is generated from at least one of the label of the image data, the text description of the image data, and the text data according to the target prompt.

In some aspects, when a recognition result of the to-be-recognized data is a type to which the text data belongs, one piece of text information may be generated from the label of the image data, the text description of the image data, the speech text, the text data, and a preset classification type according to the target prompt. For example, in this aspect, classification categories of comments may include three categories: a normal category, a vulgar category, and a non-friendly category. In S205, one piece of text information may be generated from the label of the image data, the text description of the image data, the speech text, and the text data according to the target prompt.

For example, in this aspect, the target prompt is “{ } exists in a picture, picture content is { }, corresponding speech content is { }, comments on the picture are { }, and which type in {XX, XX, XX} do the comments belong to?”. The label of the image data is, for example, label 1, the text description of the image data is, for example, text description 1, the text data is, for example, text data 1, the speech text is, for example, speech text 1, and the classification type includes a normal type, a vulgar type, and an abuse type. In this case, one piece of text information is generated from the label of the image data, the text description of the image data, the speech text, the text data, and the preset classification type according to the target prompt. The text information is: “{label 1} exists in the picture, the picture content is {text description 1}, the corresponding speech content is {speech text 1}, comments on the picture are {text data 1},and which type in {normal type, vulgar type, abuse type} do the comments belong to?”.

S206: Input the first text information into a pre-trained large language model, and output a type of the to-be-recognized data. For example, the first text information is input into a large language model. A recognition result of the input data is output.

For example, still referring to FIG. 4, the first text information “{label 1} exists in the picture, the picture content is {text description 1}, the corresponding speech content is {speech text 1}, comments on the picture are {text data 1}, and which type in {normal type, vulgar type, abuse type} do the comments belong to?” may be inputted into the pre-trained large language model, and the large language model may perform reasoning according to the inputted text information to generate the type of the comments.

The specific implementations of this disclosure are described in detail above with reference to the accompanying drawings. However, this disclosure is not limited to the specific details in the foregoing implementations, a plurality of simple deformations may be made to the technical solution of this disclosure within a range of the technical concept of this disclosure, and these simple deformations fall within the scope of this disclosure. For example, the specific technical features described in the above specific implementations can be combined in any suitable way without contradiction. In order to avoid unnecessary repetitions, various possible combination methods will not be described separately in this disclosure. For another example, various different implementations of this disclosure may alternatively be combined in other manners without departing from the idea of this disclosure. These combinations shall still be regarded as content disclosed in this disclosure.

In the method aspects of this disclosure, sequence numbers of the foregoing processes do not indicate execution sequences. The execution sequences of the processes are to be determined according to functions and internal logic of the processes, and not to be construed as any limitation to the implementation processes of the aspects of this disclosure. These sequence numbers are interchangeable where appropriate so that the described aspects of this disclosure can be implemented in an order other than those illustrated or described here.

The method aspects of this disclosure are described in detail above, and apparatus aspects of this disclosure are described in detail below with reference to FIG. 6 to FIG. 7.

FIG. 6 is a schematic block diagram of a data processing apparatus provided in an aspect of this disclosure. As shown in FIG. 6, the apparatus may include a first acquiring module 11, a second acquiring module 12, a third acquiring module 13, and a processing module 14.

The first acquiring module 11 is configured to acquire to-be-recognized data, the to-be-recognized data including image data.

The second acquiring module 12 is configured to acquire a label of the image data according to a pre-trained first multi-modal model and a preset word list, the label of the image data being configured for describing an element present in the image data; the word list being set according to a service scenario of a multi-modal recognition task, the word list including N words, and N being a positive integer.

The third acquiring module 13 is configured to acquire a text description of the image data according to a pre-trained second multi-modal model and a preset second prompt; the second prompt being configured for controlling generation of an image content description of interest to the multi-modal recognition task.

The processing module 14 is configured to generate first text information from the label of the image data and the text description of the image data according to a preset target prompt, the target prompt being set according to the service scenario of the multi-modal recognition task.

The processing module 14 is further configured to input the first text information into a pre-trained large language model, and output a recognition result of the to-be-recognized data.

In some aspects, the to-be-recognized data further includes audio data, and the first acquiring module 11 is further configured to:
acquire a speech text corresponding to the audio data.

The generating, by the processing module 14, first text information from the label of the image data and the text description of the image data according to a preset target prompt includes:
forming the first text information from the label of the image data, the text description of the image data, and the speech text according to the target prompt.

In some aspects, the to-be-recognized data further includes text data.

The generating, by the processing module 14, first text information from the label of the image data and the text description of the image data according to a preset target prompt includes:
forming the first text information from the label of the image data, the text description of the image data, and the text data according to the target prompt.

In some aspects, the acquiring, by the second acquiring module 12, a label of the image data according to a pre-trained first multi-modal model and a preset word list includes:
obtaining N pieces of second text information from each word in the word list separately according to a preset first prompt;
inputting the N pieces of second text information into a text encoder of the first multi-modal model, and outputting embedding features of the N pieces of second text information;
inputting the image data into an image encoder of the first multi-modal model, and outputting an embedding feature of the image data; and
determining the label of the image data according to similarities between the embedding feature of the image data and the embedding features of the N pieces of second text information, the label of the image data including at least one word in the word list.

In some aspects, the determining, by the second acquiring module 12, the label of the image data according to similarities between the embedding feature of the image data and the embedding features of the N pieces of second text information includes:
normalizing the similarities between the embedding feature of the image data and the embedding features of the N pieces of second text information, to obtain confidences of the N pieces of second text information; and
selecting, according to a descending order of the confidences, words corresponding to first k texts having highest confidences as k labels, k being a preset positive integer.

In some aspects, the second acquiring module 12 is further configured to:
filter the k labels according to a preset filtering mode, and determine a label remaining after the filtering as the label of the image data.

In some aspects, the acquiring, by the third acquiring module 13, a text description of the image data according to a pre-trained second multi-modal model and a preset second prompt includes:
inputting the image data and the second prompt into the second multi-modal model, and outputting the text description of the image data.

In some aspects, when the recognition result of the to-be-recognized data is a type to which the text data belongs, the generating, by the processing module 14, the first text information from the label of the image data, the text description of the image data, and the text data according to the target prompt includes:
generating the first text information from the label of the image data, the text description of the image data, the text data, and at least one classification type of the text data according to the target prompt.

According to the data processing apparatus provided in this aspect, after the to-be-recognized data is acquired, the label of the image data in the to-be-recognized data is acquired by using the pre-trained first multi-modal model and the preset word list, and the text description of the image data is acquired according to the pre-trained second multi-modal model and the preset second prompt. Next, the first text information is generated from the label of the image data and the text description of the image data according to the preset target prompt, and reasoning is performed on the first text information by using the pre-trained large language model to obtain the recognition result of the to-be-recognized data. Because the preset word list plays a role in prompting the acquiring of the image label, the second prompt plays a role in prompting the acquiring of text representation, and the first text information obtained according to the target prompt plays a role in prompting recognition of the to-be-recognized data by the large language model, in the aspects of this disclosure, the capability of the pre-trained large language model can be fully used, multi-modal recognition tasks in different service scenarios can be implemented without data labeling and model training, and computing power costs and time costs of the multi-modal recognition are reduced, thereby promoting practical application of the multi-modal recognition in each service scenario.

The apparatus aspects and the method aspects may correspond to each other. For similar descriptions, refer to the method aspects. To avoid duplication, details are not described herein again. Specifically, the apparatus shown in FIG. 6 may perform the method of the aspects shown in FIG. 2 or FIG. 3. In addition, the foregoing and other operations and/or functions of the modules in the apparatus are respectively configured for implementing the corresponding flows in the above methods. For brevity, details are not described herein.

The apparatus and system in the aspects of this disclosure are described above with reference to the accompanying drawings from the perspective of a functional module. The functional module may be implemented in a form of hardware, or may be implemented through instructions in a software form, or may be implemented through combinations of hardware and software modules. Specifically, the operations of the method in the aspects of this disclosure may be completed by an integrated logic circuit of hardware in a processor and/or instructions in a software form. The operations of the method disclosed in the aspects of this disclosure may be directly embodied as being completed by a hardware decoding processor, or may be completed by using a combination of hardware and software modules in the decoding processor. In some aspects, the software module may be located in a storage medium that is mature in the art, such as a random access memory, a flash memory, a read-only memory, a programmable read-only memory, an electrically erasable programmable memory, or a register. The storage medium is located in the memory, and the processor reads information in the memory and completes the operations in the foregoing method aspects in combination with hardware thereof.

FIG. 7 is a schematic block diagram of an electronic device 30 provided in an aspect of this disclosure.

As shown in FIG. 7, the electronic device 30 may include:
a memory 31 (for example, a non-transitory computer-readable storage medium) and a processor 32 (an example of processing circuitry), the memory 31 being configured to store a computer program and transmit a program code to the processor 32. In other words, the processor 32 may invoke and run the computer program from the memory 31 to implement the method in the aspects of this disclosure.

For example, the processor 32 may be configured to perform the above method aspects according to instructions in the computer program. For example, the processor 32 may be configured to:
acquire to-be-recognized data, the to-be-recognized data including image data;
acquire a label of the image data according to a pre-trained first multi-modal model and a preset word list, the label of the image data being configured for describing an element present in the image data; the word list being set according to a service scenario of a multi-modal recognition task, the word list including N words, and N being a positive integer;
acquire a text description of the image data according to a pre-trained second multi-modal model and a preset second prompt; the second prompt being configured for controlling generation of an image content description of interest to the multi-modal recognition task;

generate first text information from the label of the image data and the text description of the image data according to a preset target prompt, the target prompt being set according to the service scenario of the multi-modal recognition task; and
input the first text information into a pre-trained large language model, and output a recognition result of the to-be-recognized data.

In some aspects of this disclosure, processing circuitry, such as the processor 32, may include, but is not limited to:
a general-purpose processor, a digital signal processor (DSP), an application specific integrated circuit (ASIC), a field programmable gate array (FPGA), or another programmable logic device, a discrete gate or transistor logic device, or a discrete hardware component.

In some aspects of this disclosure, the memory 31 includes, but is not limited to:
a volatile memory and/or a non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM), serving as an external cache. Through an example but not restrictive description, many forms of RAMs may be used, for example, a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a direct Rambus RAM (DR RAM).

In some aspects of this disclosure, the computer program may be split into one or more modules. The one or more modules are stored in the memory 31, and are executed by the processor 32 to complete the method provided in this disclosure. The one or more modules may be a series of computer program instruction segments that can implement specific functions. The instruction segments are configured for describing an execution process of the computer program in the electronic device.

As shown in FIG. 7, the electronic device 30 may further include:
a transceiver 33, where the transceiver 33 may be connected to the processor 32 or the memory 31.

The processor 32 may control the transceiver 33 to communicate with other devices, and specifically, information or data may be transmitted to or received from the other devices. The transceiver 33 may include a transmitter and a receiver. The transceiver 33 may further include an antenna, and there may be one or more antennas.

The components in the electronic device are connected through a bus system. In addition to a data bus, the bus system further includes a power bus, a control bus, and a status signal bus.

According to an aspect of this disclosure, a communication apparatus is provided, and includes a processor and a memory. The memory is configured to store a computer program, and the processor is configured to invoke and run the computer program stored in the memory, so that an encoder performs the method in the foregoing method aspects.

According to an aspect of this disclosure, a computer storage medium, such as a non-transitory computer-readable storage medium, is provided. The computer storage medium has a computer program stored therein. The computer program, when executed by a computer, causes the computer to perform the method in the foregoing method aspects. Alternatively, the aspects of this disclosure further provide a computer program product containing instructions, and the instructions, when executed by a computer, cause the computer to perform the method in the foregoing method aspects.

According to another aspect of this disclosure, a computer program product or a computer program is provided. The computer program product or the computer program includes computer instructions. The computer instructions are stored in a computer-readable storage medium. A processor of a computer device reads the computer instructions from the computer-readable storage medium. The processor executes the computer instructions, so that the computer device performs the method in the foregoing method aspects.

In other words, when implemented by using software, all or some of the operations may be implemented in a form of a computer program product. The computer program product includes one or more computer instructions. When the computer instruction is loaded and executed on the computer, all or some processes or functions according to the aspects of this disclosure are generated. The computer may be a general-purpose computer, a special-purpose computer, a computer network, or another programmable apparatus. The computer instructions may be stored in a computer-readable storage medium, or transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) mode. The computer-readable storage medium may be any usable medium that can be accessed by the computer, or may be a data storage device, such as a server or a data center in which one or more usable media are integrated. The available medium may be a magnetic medium (for example, a floppy disk, a hard disk, or a magnetic tape), an optical medium (for example, a digital video disc (DVD)), a semiconductor medium (for example, a solid state disk (SSD)), or the like.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

It is noted that the example modules and algorithm operations described with reference to aspects disclosed in this specification can be implemented by electronic hardware, or a combination of computer software and electronic hardware. Whether the functions are executed in a mode of hardware or software depends on particular applications and design constraint conditions of the technical solutions. Those skilled in the art may use different methods to implement the described functions for each particular application, but such implementation is not to be considered beyond the scope of this disclosure.

In the several aspects provided in this disclosure, the disclosed device, apparatus, and method may be implemented in other manners. For example, the apparatus aspects described above are merely schematic. For example, the module division is merely logical function division and may be other division in actual implementation. For example, a plurality of modules or components may be combined or integrated into another system, or some features may be ignored or not performed. In addition, the displayed or discussed mutual couplings or direct couplings or communication connections may be implemented by using some interfaces. The indirect couplings or communication connections between the apparatuses or modules may be implemented in electronic, mechanical, or other forms.

The modules described as separate components may or may not be physically separated, and the components displayed as modules may or may not be physical modules, and may be located in one place or may be distributed over a plurality of network units. Some or all of the modules may be selected according to actual needs to achieve the objectives of the solutions of this aspect. For example, the functional modules in the aspects of this disclosure may be integrated in one processing module, the modules may exist alone physically, or two or more modules may be integrated in one module.

The foregoing descriptions are merely some specific implementations of this disclosure, and are not intended to limit the scope of this disclosure. Variations or replacements shall fall within the scope of this disclosure.

What is claimed is:

1. A data processing method, comprising:
acquiring input data, the input data including image data;
acquiring a label of the image data through a first multi-modal model and a word list, the label of the image data identifying at least one element present in the image data, the word list being defined for a recognition task and including N words, N being a positive integer;
acquiring, through a second multi-modal model and a second prompt, a text description of the image data, the second prompt controlling generation of an image content description corresponding to the recognition task;
generating first text information from the label of the image data and the text description of the image data based on a target prompt, the target prompt being defined for the recognition task;
inputting the first text information into a large language model; and
outputting a recognition result of the input data.

2. The method according to claim 1, further comprising:
acquiring audio data included in the input data;
acquiring recognized speech text corresponding to the audio data; and
the generating the first text information includes generating the first text information from the label of the image data, the text description of the image data, and the recognized speech text according to the target prompt.

3. The method according to claim 1, further comprising:
acquiring text data included in the input data; and
the generating the first text information includes generating the first text information from the label of the image data, the text description of the image data, and the text data based on the target prompt.

4. The method according to claim 1, wherein the acquiring the label of the image data comprises:
generating, for each of the words in the word list, a template-based text string based on a first prompt template;
inputting each of the template-based text strings into a text encoder of the first multi-modal model that is configured to output embedding features of the template-based text strings;
inputting the image data into an image encoder of the first multi-modal model that is configured to output an embedding feature of the image data; and
determining the label of the image data based on similarities between the embedding feature of the image data and the embedding features of the template-based text strings, the label of the image data including at least one word from the word list.

5. The method according to claim 4, wherein the determining the label of the image data comprises:
normalizing the similarities between the embedding feature of the image data and the embedding features of the template-based text strings to obtain confidence levels for each of the template-based text strings; and
selecting, in a descending order of the confidence levels, words corresponding to first k of the template-based text strings having highest confidence levels as k labels, k being a positive integer.

6. The method according to claim 5, further comprising:
filtering the k labels based on a filtering mode defined for the recognition task to obtain the label of the image data.

7. The method according to claim 1, wherein the acquiring the text description of the image data comprises:
inputting the image data and the second prompt into the second multi-modal model that is configured to output the text description of the image data.

8. The method according to claim 3, wherein
the recognition result includes a classification type of the text data, and
the generating the first text information includes generating the first text information from the label of the image data, the text description of the image data, the text data, and at least one classification type of the text data based on the target prompt.

9. A data processing apparatus, comprising:
processing circuitry configured to:
acquire input data, the input data including image data;
acquire a label of the image data through a first multi-modal model and a word list, the label of the image data identifying at least one element present in the image data, the word list being defined for a recognition task and including N words, N being a positive integer;
acquire, through a second multi-modal model and a second prompt, a text description of the image data, the second prompt controlling generation of an image content description corresponding to the recognition task;
generate first text information from the label of the image data and the text description of the image data based on a target prompt, the target prompt being defined for the recognition task;
input the first text information into a large language model; and
output a recognition result of the input data.

10. The apparatus according to claim 9, wherein the processing circuitry is configured to:
acquire audio data included in the input data;
acquire recognized speech text corresponding to the audio data; and
generate the first text information from the label of the image data, the text description of the image data, and the recognized speech text according to the target prompt.

11. The apparatus according to claim 9, wherein the processing circuitry is configured to:
acquire text data included in the input data; and
generate the first text information from the label of the image data, the text description of the image data, and the text data based on the target prompt.

12. The apparatus according to claim 9, wherein the processing circuitry is configured to:
generate, for each of the words in the word list, a template-based text string based on a first prompt template;
input each of the template-based text strings into a text encoder of the first multi-modal model that is configured to output embedding features of the template-based text strings;
input the image data into an image encoder of the first multi-modal model that is configured to output an embedding feature of the image data; and
determine the label of the image data based on similarities between the embedding feature of the image data and the embedding features of the template-based text strings, the label of the image data including at least one word from the word list.

13. The apparatus according to claim 12, wherein the processing circuitry is configured to:
normalize the similarities between the embedding feature of the image data and the embedding features of the template-based text strings to obtain confidence levels for each of the template-based text strings; and
select, in a descending order of the confidence levels, words corresponding to first k of the template-based text strings having highest confidence levels as k labels, k being a positive integer.

14. The apparatus according to claim 13, wherein the processing circuitry is configured to:
filter the k labels based on a filtering mode defined for the recognition task to obtain the label of the image data.

15. The apparatus according to claim 9, wherein the processing circuitry is configured to:
input the image data and the second prompt into the second multi-modal model that is configured to output the text description of the image data.

16. The apparatus according to claim 11, wherein
the recognition result includes a classification type of the text data, and
the processing circuitry is configured to generate the first text information from the label of the image data, the text description of the image data, the text data, and at least one classification type of the text data based on the target prompt.

17. A non-transitory computer-readable storage medium storing instructions which, when executed by a processor, cause the processor to perform:
acquiring input data, the input data including image data;
acquiring a label of the image data through a first multi-modal model and a word list, the label of the image data identifying at least one element present in the image data, the word list being defined for a recognition task and including N words, N being a positive integer;
acquiring, through a second multi-modal model and a second prompt, a text description of the image data, the second prompt controlling generation of an image content description corresponding to the recognition task;
generating first text information from the label of the image data and the text description of the image data based on a target prompt, the target prompt being defined for the recognition task;
inputting the first text information into a large language model; and
outputting a recognition result of the input data.

18. The non-transitory computer-readable storage medium according to claim 17, wherein
the instructions, when executed by a processor, cause the processor to perform:
acquiring audio data included in the input data, and
acquiring recognized speech text corresponding to the audio data; and
the generating the first text information includes generating the first text information from the label of the image data, the text description of the image data, and the recognized speech text according to the target prompt.

19. The non-transitory computer-readable storage medium according to claim 17, wherein
the instructions, when executed by a processor, cause the processor to perform:
acquiring text data included in the input data; and
the generating the first text information includes generating the first text information from the label of the image data, the text description of the image data, and the text data based on the target prompt.

20. The non-transitory computer-readable storage medium according to claim 17, wherein the instructions, when executed by a processor, cause the processor to perform:
generating, for each of the words in the word list, a template-based text string based on a first prompt template;
inputting each of the template-based text strings into a text encoder of the first multi-modal model that is configured to output embedding features of the template-based text strings;
inputting the image data into an image encoder of the first multi-modal model that is configured to output an embedding feature of the image data; and
determining the label of the image data based on similarities between the embedding feature of the image data and the embedding features of the template-based text strings, the label of the image data including at least one word from the word list.
